(19) United States
(12) Patent Application Publication
(10) Pub. No.: US 2023/0004332 A1
(43) Pub. Date: Jan. 5, 2023

(54) PRINTING SYSTEM, NON-TRANSITORY COMPUTER-EXECUTABLE MEDIUM, AND IMAGE FORMING APPARATUS

(71) Applicant: Akira MIYATA, Saitama (JP)

(72) Inventor: Akira MIYATA, Saitama (JP)

(21) Appl. No.: 17/849,705

(22) Filed: Jun. 27, 2022

(30) Foreign Application Priority Data
Jun. 30, 2021 (JP) 2021-109038
Jun. 1, 2022 (JP) 2022-089468

(51) Int. Cl. G06F 3/12

(52) U.S. Cl. CPC G06F 3/1205; G06F 3/1258

(57) ABSTRACT

A printing system that is communicable with an image management server through a network includes an information processing apparatus and an image forming apparatus. The information processing apparatus controls a display to display a print setting screen for receiving a print setting that designates printing of a specific color image superimposed on an image to be printed, transmits the specific color image corresponding to the print setting to the image management server, acquires storage location information from the image management server, and transmits print data to the image forming apparatus. The image forming apparatus includes a printer. The image forming apparatus receives the print data, acquires the specific color image from the image management server, generates image data for overprinting the specific color image on the image to be printed, and controls the printer to perform printing based on the image data.

### CROSS-REFERENCE TO RELATED APPLICATIONS

This patent application is based on and claims priority pursuant to 35 U.S.C. § 119(a) to Japanese Patent Application Nos. 2021-109038, filed on Jun. 30, 2021, and 2022-089468, filed on Jun. 1, 2022, in the Japan Patent Office, the entire disclosures of which are hereby incorporated by reference herein.

### BACKGROUND

### Technical Field

Embodiments of this disclosure relate to a printing system, a non-transitory computer-executable medium, and an image forming apparatus.

### Related Art

Various characteristics are desired in toners used for image formation by laser printers and the like from the viewpoints of development, transfer, and fixing of the toner and image quality. For example, a technology is known of forming an image with a toner that reflects or absorbs light of a specific wavelength. Further, a technology is known of mixing an infrared absorber in a standard color toner of cyan (C), magenta (M), yellow (Y), and black (K) for image formation.

### SUMMARY

An embodiment of the present disclosure includes a printing system that is communicable with an image management server through a network. The printing system includes an information processing apparatus including first circuitry, and an image forming apparatus including second circuitry. The first circuitry of the information processing apparatus controls a display to display a print setting screen for receiving a print setting that designates printing of a specific color image superimposed on an image to be printed, the specific color image being an image of a specific color. The first circuitry of the information processing apparatus, in response to receiving the print setting via the print setting screen, transmits the specific color image corresponding to the print setting to the image management server through the network. The first circuitry of the information processing apparatus acquires storage location information indicating a storage location where the specific color image is stored from the image management server. The first circuitry of the information processing apparatus transmits print data to the image forming apparatus, the print data including a printing command including the print setting indicating that the specific color image is to be superimposed and printed on the image to be printed, the image to be printed, and the acquired storage location information. The image forming apparatus includes a printer. The second circuitry of the image forming apparatus receives the print data. The second circuitry of the image forming apparatus acquires the specific color image from the image management server based on the storage location information included in the received print data. The second circuitry of the image forming apparatus generates, based on the printing command included in the print data, image data for overprinting the specific color image acquired from the image management server on the image to be printed included in the print data. The second circuitry of the image forming apparatus controls the printer to perform printing based on the generated image data.

Another embodiment of the present disclosure includes a non-transitory computer-executable medium storing a program storing instruction, which, when executed by one or more processors of an information processing apparatus that transmits print data to an image forming apparatus and is communicable with an image management server through a network, to perform a method. The method includes controlling a display to display a print setting screen for receiving a print setting that designates printing of a specific color image superimposed on an image to be printed, the specific color image being an image of a specific color. The method includes, in response to receiving the print setting via the print setting screen, transmitting the specific color image corresponding to the print setting to the image management server through the network. The method includes acquiring storage location information indicating a storage location where the specific color image is stored from the image management server. The method includes transmitting print data to the image forming apparatus, the print data including a printing command including the print setting indicating that the specific color image is to be superimposed and printed on the image to be printed, the image to be printed, and the acquired storage location information.

Another embodiment of the present disclosure includes an image forming apparatus communicable with an image management server through a network. The image forming apparatus includes a printer and circuitry. The circuitry receives print data from an information processing apparatus. The information processing apparatus including another circuitry. The another circuitry controls a display to display a print setting screen for receiving a print setting that designates printing of a specific color image superimposed on an image to be printed, the specific color image being an image of a specific color. The another circuitry, in response to receiving the print setting via the print setting screen, transmits the specific color image corresponding to the print setting to the image management server through the network. The another circuitry acquires storage location information indicating a storage location where the specific color image is stored from the image management server. The another circuitry transmits the print data to the image forming apparatus, the print data including a printing command including the print setting indicating that the specific color image is to be superimposed and printed on the image to be printed, the image to be printed, and the acquired storage location information. The circuitry acquires the specific color image from the image management server based on the storage location information included in the received print data. The circuitry generates, based on the printing command included in the print data, image data for overprinting the specific color image acquired from the image management server on the image to be printed included in the print data. The circuitry controls the printer to perform printing based on the generated image data.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1A and FIG. 1B are diagrams illustrating printing using a spot color, according to the comparative art;

FIG. 2A and FIG. 2B illustrate examples of a print image, an infrared (IR) toner image, and a printed result, according to an embodiment of the present disclosure;

FIG. 3 is a flowchart illustrating an overview of an operation performed by a printing system, according to an embodiment of the present disclosure;

FIG. 4 is a schematic diagram illustrating a configuration of the printing system, according to an embodiment of the present disclosure;

FIG. 5 is a block diagram illustrating an example of a hardware configuration of each of an information processing apparatus and an IR image management server, according to an embodiment of the present disclosure;

FIG. 6 is a block diagram illustrating an example of a hardware configuration of an image forming apparatus, according to an embodiment of the present disclosure;

FIG. 7 is a block diagram illustrating an example of functional configurations of the information processing apparatus and the IR image management server, according to an embodiment of the present disclosure;

FIG. 8 is a diagram illustrating image management tables that an IR toner image management application includes, according to an embodiment of the present disclosure;

FIG. 9A, FIG. 9B, and FIG. 9C are diagrams illustrating examples of a configuration of an IR image management table, according to an embodiment of the present disclosure;

FIG. 10 is a block diagram illustrating a functional configuration of the image forming apparatus, according to an embodiment of the present disclosure;

FIG. 11 is a flowchart illustrating an example of processes or operation performed by a printer driver, according to an embodiment of the present disclosure;

FIG. 12 is a diagram illustrating an example of a print setting screen, according to an embodiment of the present disclosure;

FIG. 13 is a flowchart illustrating an example of processes or operation performed by the IR toner image management application of receiving user settings for generating the IR image management table, according to an embodiment of the present disclosure;

FIG. 14 is a flowchart illustrating an example of processes or operation performed by the IR toner image management application when the printer driver invokes the IR toner image management application, according to an embodiment of the present disclosure;

FIG. 15 is a flowchart illustrating an example of processes or operation performed by the IR image management server of transmitting a uniform resource locator (URL) to the IR toner image management application in response to receiving an IR toner image and a print position, according to an embodiment of the present disclosure;

FIG. 16 is a flowchart illustrating an example of processes or operation performed by the image forming apparatus of performing printing according to print data, according to an embodiment of the present disclosure;

FIG. 17 is a diagram for describing an operation of printing with the IR toner performed by the image forming apparatus, according to an embodiment of the present disclosure; and

FIG. 18A, FIG. 18B, and FIG. 18C are diagrams illustrating an example of overprint, according to an embodiment of the present disclosure.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Referring to drawings, a printing system and a printing method performed by the printing system according to example embodiments of the present disclosure are described.

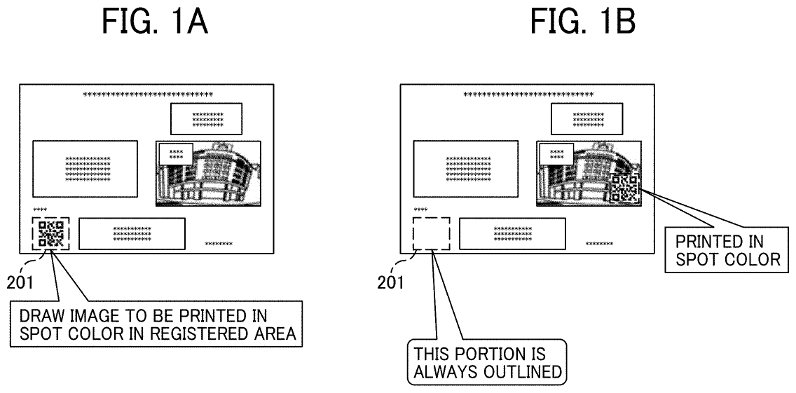

FIGS. 1A and 1B are diagrams illustrating printing using a spot color according to the comparative art. FIGS. 1A and 1B are diagrams illustrating a comparative method for printing with a spot color (special color or particular color) toner, using general-purpose application software that handles red, green, and blue (RGB) image data (application software that does not create a spot color layer). In this example, as illustrated in FIG. 1A, a user embeds, in a portion 201 of an image to be printed, an embedded image to be printed with a spot color toner. The embedded image is, for example, a barcode to be printed with an infrared (IR) toner (hereinafter referred to as the IR toner image).

An image forming apparatus 30 cuts out the IR toner image from the portion 201, whose position is designated, of the print image and superimposes the IR toner image on a different designated position (a photograph area in FIG. 1B). Accordingly, the portion 201 of the print image as the result remains white. Although the image forming apparatus 30 can keep the IR toner image in the portion 201 of the print image, it is not preferable that the barcode or the like remains. As describe, an area for the IR toner image is required in the print image. This causes an inconvenience that not the entire page is usable for a user to design the print image.

Overview of Operation of Printing System:

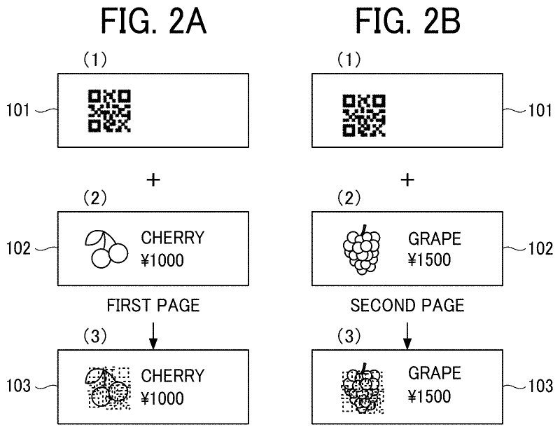

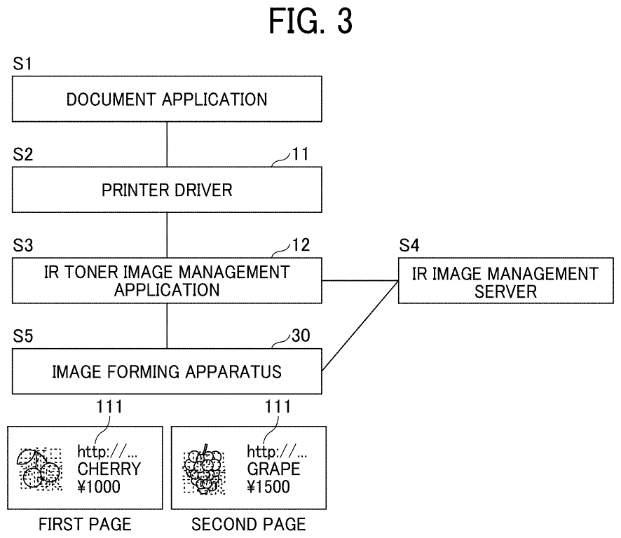

Referring to FIG. 2A, FIG. 2B, and FIG. 3, an overview of how the image forming apparatus 30 forms an image with a spot color is described, according to the present embodiment. FIG. 2A and FIG. 2B illustrate examples of the print image, the IR toner image, and a printed result. Although FIG. 2A and FIG. 2B are different in that FIG. 2A indicates a first page in the print image and FIG. 2B indicates a second image in the print image, the processing flow is the same except that the print result differs depending on the page difference. FIG. 3 is a flowchart illustrating an overview of an operation performed by a printing system 100 according to the present embodiment. The operation of FIG. 3 is performed mainly by an information processing apparatus 10 and the image forming apparatus 30.

(1) The information processing apparatus 10 includes application software that handles a plurality of IR toner images (e.g., barcodes in FIG. 2A and FIG. 2B). The application software receives, from a user, designation of an IR toner image 101 for each page at the time of printing. In the following, this application software is referred to as an “IR toner image management application 12”. The IR toner image management application 12 also stores an association between each page of the print image and the IR toner image.

(2) The user operates general-purpose application software to prepare a print image 102 to be printed. Each of a picture of cherries accompanied by a price in FIG. 2A and a picture of grapes accompanied by a price in FIG. 2B is the print image 102.

(3) In response to an instruction for printing from the user, the image forming apparatus 30 prints the print image 102 on which the IR toner image 101 is superimposed. A printed matter 103 is output in which the IR toner image 101 is superimposed on the print image 102, the IR toner image being transparent to the naked eye.

The operation is described below with reference to FIG. 3.

In step S1, a user operates a general-purpose application software to prepare a print image to be printed.

In step S2, in response to designation by the user of printing with the IR toner, a printer driver 11 invokes (activates) the IR toner image management application 12. The printer driver 11 transfers print data of the print image to the IR toner image management application 12.

In step S3, the user operates the IR toner image management application 12 to designate, for each page in the print image, the IR toner image and a print position at which the IR toner image is to be printed. The print position is an example of position information.

In step S4, the IR toner image management application 12 transmits the IR toner image and information on the print position to an IR image management server 50. After storing the received IR toner image and print position, the IR image management server 50 generates a uniform resource locator (URL) indicating a storage location and transmits the URL to the IR toner image management application 12. The IR toner image management application 12 draws the URL received from the IR image management server 50 at a predetermined position of the print image. The IR toner image management application 12 sets a printing command indicating that the URL is a storage location of the IR toner image and the IR toner image is to be printed in a specific color. The IR toner image management application 12 performs the same processes for all pages and transmits the print image to the image forming apparatus 30.

In step S5, the image forming apparatus 30 acquires a URL 111 from a predetermined position of each page. In a case that the printing command includes a setting indicating that the URL 111 relates to IR toner printing, the image forming apparatus 30 acquires the IR toner image and the print position from the storage location indicated by the URL 111. The image forming apparatus 30 overprints the IR toner image with the IR toner at the print position of the print image. Details of the overprinting is described below with reference to FIG. 18A to FIG. 18C. Thus, the image forming apparatus 30 prints the print image on which the IR toner image is superimposed.

In this way, the printer driver 11 receives the designation of the IR toner printing and transfers the print data to the IR toner image management application 12. The IR toner image management application 12 associates the IR toner image designated by the user with the print image. After processing all pages, the IR toner image management application 12 returns the print data to the printer driver 11, and the printer driver 11 transfers the processed print data to the image forming apparatus 30. The image forming apparatus 30 analyzes the print data for each page. Based on the analysis result indicating that the printing command for printing with the IR toner is added, the image forming apparatus 30 overprints the IR toner image on the print image with the IR toner.

With this configuration, the printing system 100 can perform printing using the IR toner with a general-purpose application that handles RGB image data. Further, the printing system 100 allows the user to use the entire page to design a print image.

### Terms

The term “specific color” (spot color or special color) refers to a color other than cyan, magenta, yellow, and black (these are called process colors). For example, the specific color is gold, silver, white, or transparent. Since some image forming apparatus 30 (particularly inkjet type) can use inks of different colors in addition to cyan, magenta, yellow, and black, the spot color may be different depending on the image forming apparatus 30. Further, the specific color (spot color) can be a color that is not expressed with RGB by the application software. A coloring material such as toner or ink capable of printing a spot color is called a spot color material (or special color material). In the present embodiment, the color of the IR toner is the spot color.

Further, the term “transparent” refers to being invisible to light of a certain wavelength. Being “transparent” is not necessarily completely invisible. Being “transparent” satisfies at least one of seemingly invisible and not capturable by an imaging device. The transparent toner or ink may be called stealth toner or stealth ink.

In the present embodiment, for example, the image forming apparatus 30 in which a spot color is assigned to black is used, instead of an image forming apparatus capable of designating and printing a spot color other than cyan, magenta, yellow, and black. In other words, the colors handled by the image forming apparatus 30 can be only cyan, magenta, yellow, and black. The image forming apparatus 30 according to the present embodiment does not use black toner, and the black toner cartridge contains a spot color material. However, an image forming apparatus (that handles cyan, magenta, yellow, black, and spot color) capable of designating and printing a spot color can also be used as the image forming apparatus 30.

A specific color image is an image printed in a spot color. In the present embodiment, a description is given of an example in which the specific color image is an IR toner image.

Example of System Configuration:

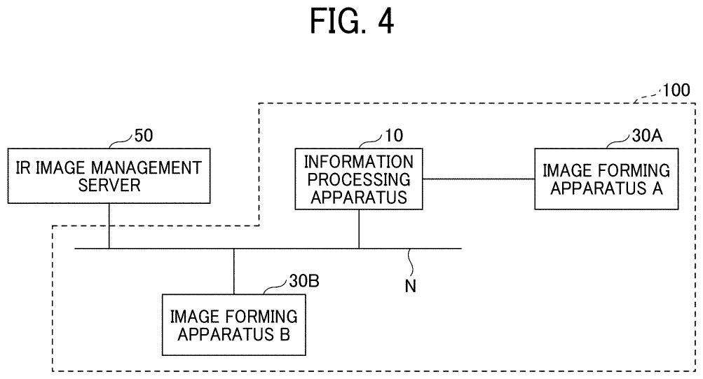

FIG. 4 is a schematic diagram illustrating a configuration of the printing system 100. The printing system 100 illustrated in FIG. 4 includes the information processing apparatus 10 and one or more image forming apparatuses 30. The information processing apparatus 10 and the image forming apparatuses 30 are communicably connected with the IR image management server 50. The image forming apparatus 30 connected to the information processing apparatus 10 through a dedicated network is referred to as an “image forming apparatus 30A”. The image forming apparatus 30 connected via a network N is referred to as an “image forming apparatus 30B”. Any one of the image forming apparatus 30A and the image forming apparatus 30B is referred to as the “image forming apparatus 30”.

The information processing apparatus 10 and the image forming apparatus 30A are connected peer to peer (one-to-one) by the dedicated network such as a universal serial bus (USB) cable. However, the connection therebetween is not necessarily constantly maintained, and a user can attach and detach the dedicated network. In addition to the USB cable, examples of the dedicated line include, a personal computer (PC) card, a peripheral component interconnect (PCI) bus, an Institute of Electrical and Electronics Engineers (IEEE) 1394 bus, and a small computer system interface (SCSI).

In another example, the information processing apparatus 10 and the image forming apparatus 30A are wirelessly connected to each other so as to communicate with each other. Examples of peer to peer wireless communication include Bluetooth® and wireless local area network (LAN).

The information processing apparatus 10 is communicably connected to the image forming apparatus 30B via the network N. The network N is assumed to be a general-purpose network such as a LAN or the Internet. The LAN is, for example, a LAN in a facility such as an office where the image forming apparatus 30B is installed. In another example, the network N further includes a virtual private network (VPN) and a wide area Ethernet®. The network N is configured as one or both of a wired network and a wireless network.

The information processing apparatus 10 executes various control programs, such as an operating system (OS) and the printer driver 11, and application software, to provide functions corresponding to the application software. The information processing apparatus 10 is often called a computer. The control program is, for example, a program that is so-called a device driver (software prepared to enable the OS to control hardware and the like connected to a personal computer). An example of the device driver is the printer driver 11. Specific examples of the information processing apparatus 10 include a PC, a smartphone, a tablet terminal, a personal digital assistant (PDA), and a wearable PC.

Other examples of the information processing apparatus 10 include an electronic whiteboard capable of mutual communication, an output device such as digital signage, a projector, and a videoconference terminal. In other words, any suitable apparatus is used as the information processing apparatus 10, provided that the OS, control program, and application software operate on the apparatus.

The image forming apparatus 30 forms an image such as characters (text) or FIGS. mainly with toner or ink on a recording medium. The image forming apparatus 30 according to the present embodiment is capable of printing cyan, magenta, and yellow image data with a toner or ink that is visible to the naked eye and is further capable of printing black image data with a spot color material (toner or ink). The toner or ink that is visible to the naked eye is hereinafter referred to as “visible material” The image forming apparatus 30 is capable of forming an image on one recording medium using both the visible material and the spot color material. Alternatively, the image forming apparatus 30 is also capable of forming an image using only one of the visible material and the spot color material.

Usable as the spot color material is a toner or ink that has absorbency in the wavelength range (around 850 nm) of infrared light including near-infrared light and has less absorbency in the wavelength range of visible light (about 400 to 700 nm). In other words, in the spot color material, the absorbency in the visible wavelength range is smaller than the absorbency in the infrared wavelength range. Such a spot color material is transparent (invisible) to visible light and legible when irradiated with infrared light. In other words, the spot color means transparent to visible light. When irradiated with infrared light, the spot color material absorbs infrared light and looks black. The colors cyan, magenta, and yellow are transparent to infrared light. On the other hand, there are two kinds of black materials (ordinary black toner). One kind of black material absorbs infrared light and the other kind of black material does not absorb infrared light. When a black image that absorbs infrared light is formed together with an image of the spot color material, both images look black, making it difficult to recognize a barcode or the like formed with the spot color material. In this case, it is not desirable to form the black image that absorbs infrared light and the spot color image on the same sheet. On the other hand, when a black image that does not absorb infrared light is formed together with the spot color image, only the spot color image looks black when irradiated with infrared light. Accordingly, a barcode or the like formed with the spot color material is recognizable. In the present embodiment, a description is given of the image forming apparatus 30 that performs printing without using black color. For this reason, black is expressed by superimposing cyan, magenta, and yellow. In another example, printing is performed using five colors of cyan, magenta, yellow, black that does not absorb infrared light, and spot color.

Since the spot color material can be used to print information used for determining the authenticity of an output product, the spot color material has the effect of inhibiting duplication of the output product. Since the security is improved, the spot color material can be said to be a consumer material for security.

In another example, the spot color material is toner or ink having absorbency relative to ultraviolet light (UV) and a small absorbency relative to visible light. In still another example, an image is formed with material that is transparent in a normal state and is chemically changed and rendered visible by application of heat, laser, or chemicals, etc. In still another example, information that is difficult to be recognized with the naked is formed by an uneven surface.

Any suitable material to which toner or ink can adhere is used as the recording medium on which the image forming apparatus 30 performs printing. Specifically, the recording medium is a medium on which the toner or ink can temporarily adhere and then solidify or permeate. Specific examples of the recording medium include recording media such as paper, recording paper, film, and cloth; electronic components such as electronic boards and piezoelectric elements; and powder layers (particle layers), and any material to which the toner or ink adheres is included unless otherwise specified.

The above-mentioned “material to which toner or ink can adhere” includes any material, such as paper, thread, fiber, cloth, leather, metal, plastic, glass, wood, ceramics, or the like, provided that toner or ink can temporarily adhere.

The image forming apparatus 30 includes an electrophotographic printer, an inkjet printer that discharges liquid (droplets), and a printer that thermally transferring an ink ribbon. In another example, the image forming apparatus 30 is a multifunction peripheral. The “multifunction” of the multifunction peripheral means having a plurality of functions of, for example, image forming, facsimile transmission and reception, scanning of a document, and copying. The multifunction peripheral is sometimes called an MFP. In the present embodiment, the image forming apparatus 30 having the image forming function will suffice. The image forming apparatus 30 may also be called a printer.

The IR image management server 50 is an information processing system having one or more computers. Any suitable computer is used as the IR image management server 50, provided that the computer creates a storage location of the IR toner image and the print position. For this reason, the IR image management server 50 does not have to be called as a server. In one example, the IR image management server 50 resides on the Internet. In another example, the IR image management server 50 resides in an on-premises environment. In one example, the IR image management server 50 supports cloud computing. The “cloud” is a term used when specific hardware resources are not intended.

Hardware Configuration:

Descriptions are given below of the hardware configurations of the information processing apparatus 10, the image forming apparatus 30, and the IR image management server 50 of the printing system 100.

Information Processing Apparatus and IR Image Management Server:

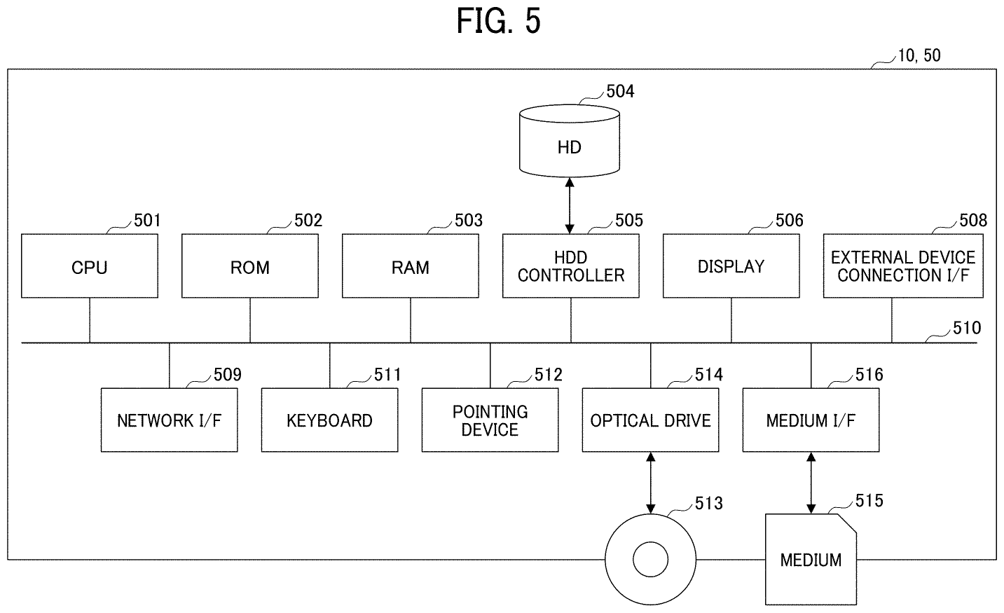

FIG. 5 is a block diagram illustrating an example of a hardware configuration of each of the information processing apparatus 10 and the IR image management server 50, according to the present embodiment. As illustrated in FIG. 5, each of the information processing apparatus 10 and the IR image management server 50 is implemented by a computer. As illustrated in FIG. 5, the computer includes a central processing unit (CPU) 501, a read only memory (ROM) 502, a random access memory (RAM) 503, a hard disk (HD) 504, a hard disk drive (HDD) controller 505, a display 506, an external device connection interface (I/F) 508, a network I/F 509, a data bus 510, a keyboard 511, a pointing device 512, an optical drive 514, and a medium I/F 516.

The CPU 501 controls the entire operations of the information processing apparatus 10 and the IR image management server 50. The ROM 502 stores programs such as an initial program loader (IPL) to boot the CPU 501. The RAM 503 is used as a work area for the CPU 501. The HD 504 stores various data such as programs. The HDD controller 505 controls reading or writing of various data with respect to the HD 504 under control of the CPU 501. The display 506 displays various information such as cursors, menus, windows, characters, or images. The external device connection I/F 508 is an interface that connects the information processing apparatus 10 and the IR image management server 50 to various external devices. Examples of the external devices include a USB memory and a printer. The network I/F 509 is an interface for performing data communication using the network N. The data bus 510 is, for example, an address bus or a data bus, which electrically couples the components illustrated in FIG. 5, such as the CPU 501.

The keyboard 511 is one example of an input device provided with a plurality of keys for allowing a user to input characters, numerals, or various instructions. The pointing device 512 is an example of an input device that allows a user to select or execute various instructions, select an item to be processed, or move the cursor being displayed. The optical drive 514 controls reading or writing of various data with respect to an optical storage medium 513, which is an example of a removable storage medium. The optical drive 514 is, for example, a compact disc (CD) drive, a digital versatile disk (DVD) drive, or a Blu-Ray® drive. The medium I/F 516 controls reading or writing (storing) of data with respect to a storage medium 515 such as a flash memory.

Image Forming Apparatus:

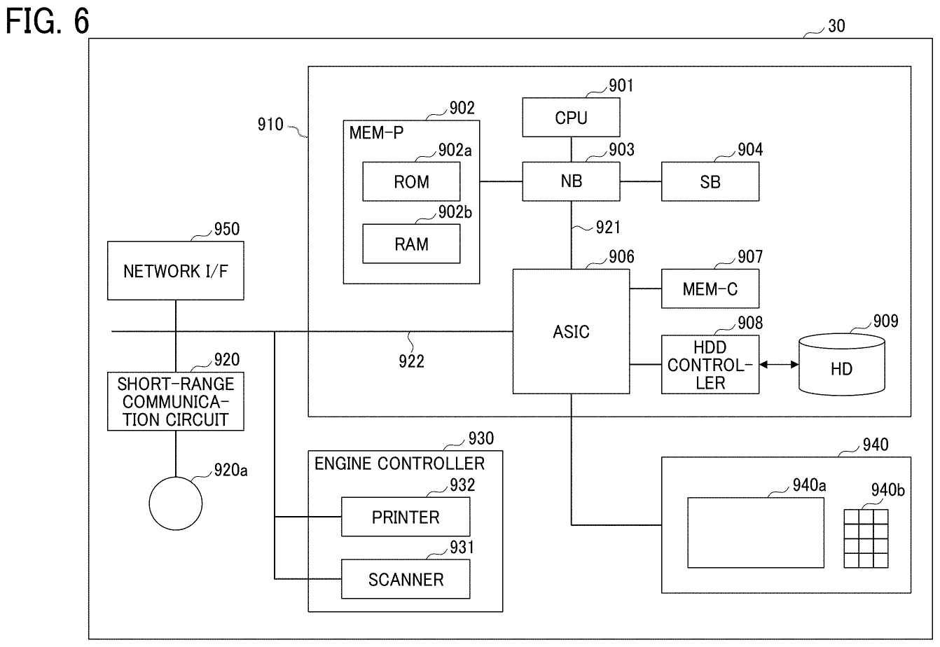

FIG. 6 is a block diagram illustrating an example of a hardware configuration of the image forming apparatus 30. As illustrated in FIG. 6, the image forming apparatus 30 includes a controller 910, a short-range communication circuit 920, an engine controller 930, a control panel 940, and a network I/F 950.

The controller 910 includes a CPU 901 as a main processor of a computer, a system memory (MEM-P) 902, a north bridge (NB) 903, a south bridge (SB) 904, an application specific integrated circuit (ASIC) 906, a local memory (MEM-C) 907 as a storage area, an HDD controller 908, and an HD 909 as a storage area. The NB 903 and the ASIC 906 are connected by an accelerated graphics port (AGP) bus 921.

The CPU 901 is a processor that controls overall operation of the image forming apparatus 30. The NB 903 connects the CPU 901, with the system memory 902, the SB 904, and the AGP bus 921. The NB 903 includes a memory controller for controlling reading or writing of data with respect to the system memory 902, a PCI master, and an AGP target.

The system memory 902 includes a ROM 902a and a RAM 902b. The ROM 902a is a memory that stores a program and data for implementing various functions of the controller 910. The RAM 902b is used as a memory that deploys a program and data, or as a drawing memory that stores drawing data for printing. For example, the program stored in the ROM 902a is stored in any computer-readable storage medium, such as a compact disc-read only memory (CD-ROM), compact disc-recordable (CD-R), or DVD, in a file format installable or executable by a computer, for distribution.

The SB 904 is a bridge that connects the NB 903 to a PCI device or a peripheral device. The ASIC 906 is an integrated circuit (IC) for image processing having a hardware element for image processing and acts as a bridge that connects the AGP bus 921, a PCI bus 922, the HDD controller 908, and the local memory 907 to each other. The ASIC 906 includes a PCI target, an AGP master, an arbiter (ARB) as a central processor of the ASIC 906, a memory controller to control the local memory 907, a plurality of direct memory access controllers (DMACs), and a PCI unit. The DMACs is capable of converting coordinates of image data with a hardware logic. The PCI unit transfers data between a scanner 931 and a printer 932 through the PCI bus 922. In one example, the ASIC 906 is connected to a USB interface, or the IEEE 1394 interface.

The local memory 907 is used as an image buffer for copying or a code buffer. The HD 909 is a storage that stores image data, font data for printing, and form data. The HDD controller 908 controls reading or writing of data with respect to the HD 909 under the control of the CPU 901. The AGP bus 921 is a bus interface for a graphics accelerator card, which has been proposed to accelerate graphics processing. Through directly accessing the system memory 902 by high-throughput, speed of the graphics accelerator card is improved.

The short-range communication circuit 920 includes a short-range communication antenna 920a. The short-range communication circuit 920 is a communication circuit that communicates in compliance with the near field communication (NFC) or the Bluetooth®, for example.

The engine controller 930 includes the scanner 931 and the printer 932. The control panel 940 includes a panel display 940a and hardware keys 940b. The panel display 940a is, e.g., a touch panel that displays current settings or a selection screen and that receives a user input. The hardware keys 940b include, e.g., a numeric keypad and a start key. The numeric keypad receives assigned values of image forming parameters such as an image density parameter. The start key receives an instruction to start copying. The controller 910 controls overall operation of the image forming apparatus 30 and controls, for example, drawing, communication, and input from the control panel 940. The scanner 931 or the printer 932 includes an image processing unit for, for example, error diffusion and gamma conversion.

In response to an instruction to select a specific application through the control panel 940 by use of, e.g., an application (or mode) switch key, the image forming apparatus 30 selectively performs a document server function, a copier function, a printer function, and a facsimile function. In response to selection of the document server function, the image forming apparatus 30 operates in a document server mode to store document data. In response to selection of the copier function, the image forming apparatus 30 operates in a copier mode. In response to selection of the printer function, the image forming apparatus 30 operates in a printer mode. In response to selection of the facsimile function, the image forming apparatus 30 operates in a facsimile mode.

The network I/F 950 is an interface for performing data communication using the network N. The short-range communication circuit 920 and the network I/F 950 are electrically connected to the ASIC 906 via the PCI bus 922.

Functions of Information Processing Apparatus and Image Forming Apparatus:

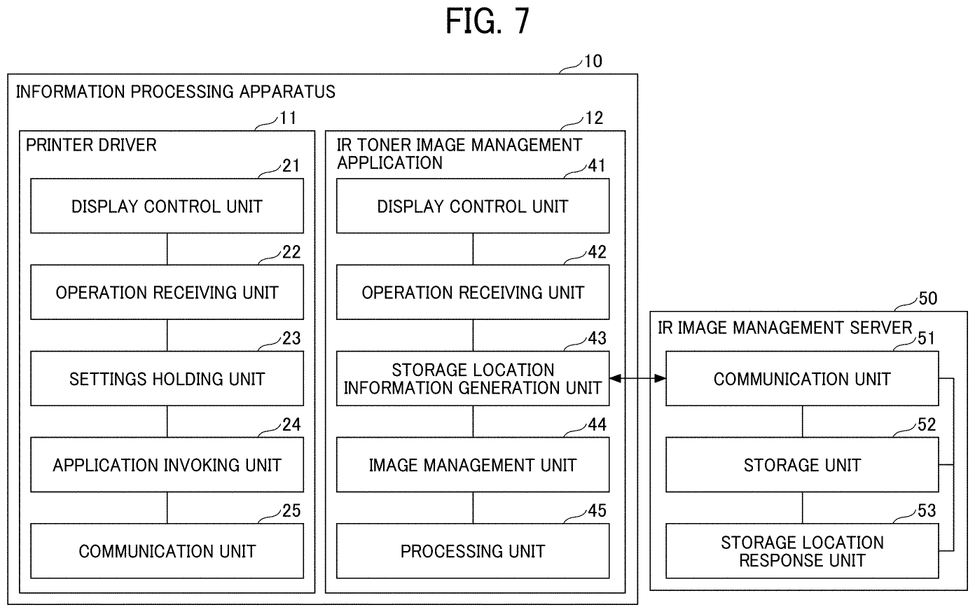

Referring to FIG. 7 to FIG. 10, functions of the information processing apparatus 10 and the image forming apparatuses 30 are described.

Functions of Information Processing Apparatus:

FIG. 7 is a block diagram illustrating an example of a functional configuration of the information processing apparatus 10. In the information processing apparatus 10, two programs, namely, the printer driver 11 and the IR toner image management application 12 operate. The general-purpose application software for invoking the printer driver 11 is omitted in FIG. 7 in order to simplify the drawing.

This general-purpose application software may be any software that is capable of invoke the printer driver 11. Examples of the general-purpose application include word processing software, presentation software, spreadsheet software, portable document format (PDF) software, and browser software. Each of such application software saves and reads a file in the corresponding format. FIG. 7 illustrates an example in which the functional units of the information processing apparatus 10 are divided into two programs. In another example, the printer driver 11 has a function of the IR toner image management application 12.

When printing a document, the user invokes the printer driver 11 from application software, and the printer driver 11 automatically activates the IR toner image management application 12. In the IR toner image management application 12, the user can designate an IR toner image for each page (is some cases, the IR toner image is not designated depending on the page). The user can also designate the position of the print image in the IR toner image. With this configuration, the user only has to operate the IR toner image management application 12 in addition to the conventional work for printing a document on the application software. Thus, the operability does not easily degrade.

Functions of Printer Driver:

The printer driver 11 includes a display control unit 21, an operation receiving unit 22, a settings holding unit 23, an application invoking unit 24, and a communication unit 25. These units of the printer driver 11 are functions or means implemented by or caused to function by operating one or more hardware components illustrated in FIG. 5 in cooperation with instructions of the CPU 501 according to the printer driver 11 loaded from the HD 504 to the RAM 503.

The display control unit 21 displays a print setting screen (a user interface: UI) on which the printer driver 11 accepts print settings. The operation receiving unit 22 receives print settings and settings from the user as to whether to perform printing using the IR toner. The print settings include setting of color or monochrome, number of copies, double-sided copy, and combining pages. The settings holding unit 23 stores the setting of whether to perform printing with the IR toner, which the operation receiving unit 22 receives from the user.

The application invoking unit 24 invokes the IR toner image management application 12 based on the settings stored by the settings holding unit 23, and transfers print data to the IR toner image management application 12. Further, the application invoking unit 24 receives the print data processed by the IR toner image management application 12.

The communication unit 25 is communicable with the image forming apparatus 30, and transmits print data to the image forming apparatus 30. The communication unit 25 is an example of a first communication unit.

Functions of IR Toner Image Management Application:

The IR toner image management application 12 includes a display control unit 41, an operation receiving unit 42, a storage location information generation unit 43, an image management unit 44, and a processing unit 45. These units of the IR toner image management application 12 are functions or means implemented by or caused to function by operating one or more hardware components illustrated in FIG. 5 in cooperation with instructions of the CPU 501 according to the IR toner image management application 12 loaded from the HD 504 to the RAM 503.

The display control unit 41 displays a screen of the IR toner image management application 12. This screen allows the user to designate the combination of each page of the print image and the IR toner image and designate the print position of the IR toner image. The operation receiving unit 42 receives the designation of the combination of each page of the print image and the IR toner image and the designation of the print position of the IR toner image.

The storage location information generation unit 43 transmits, for each page, the IR toner image and the print position to the IR image management server 50, and receives a URL indicating a storage location of IR toner image and the print position for each page.

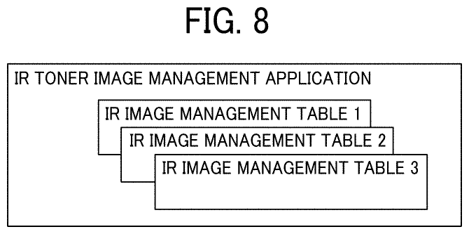

The image management unit 44 manages the IR toner image to be associated with the print image. In one example, the user registers the IR toner image in advance. In another example, the user registers the IR toner image at the time of printing using the IR toner. Details of the IR toner image managed by the image management unit 44 are described below with reference to FIG. 8.

The processing unit 45 draws the URL on each page of the print image. A printing command corresponding to the URL is added to a page on which the IR toner image is to be printed. The printing command indicates that the URL relates to printing with IR toner. A position where the URL is to be drawn is set in advance. It is preferable that the URL is printed with spot color toner (black in the present embodiment).

FIG. 8 is a diagram illustrating image management tables that the IR toner image management application 12 includes. As illustrated in FIG. 8, the IR toner image management application 12 has one IR image management table n (n is an integer equal to or greater than 1) for each IR toner image. The IR image management table n is a table for managing the IR toner image. The user is allowed to register a new IR image management table and edit and delete an existing IR image management table.

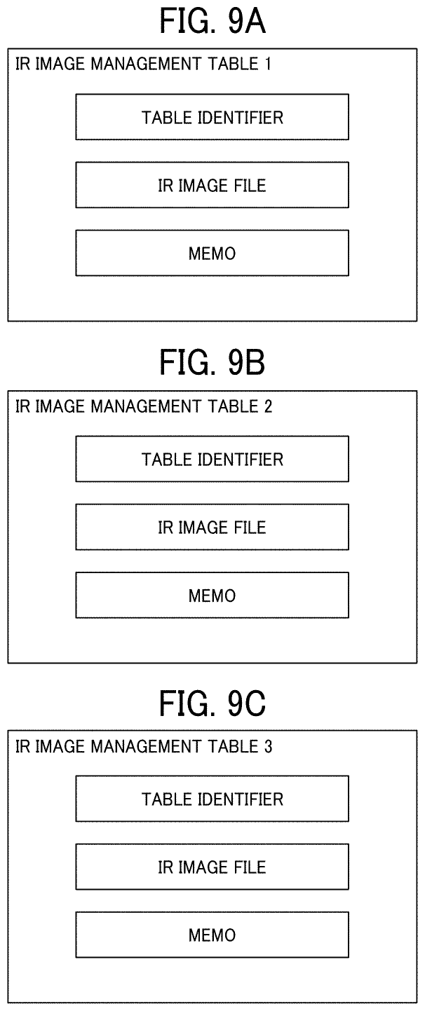

FIG. 9A to FIG. 9C are diagrams illustrating examples of the configuration of the IR image management table. FIG. 9A illustrates a configuration of the IR image management table 1. FIG. 9B illustrates a configuration of the IR image management table 2. FIG. 9C illustrates a configuration of the IR image management table 3. As illustrated in FIG. 9A to FIG. 9C, in the IR image management table n, a table identifier identifying the IR toner image, an IR image file in which the IR toner image is stored, and a memo are registered. The table identifier, the IR image file, and the memo are registered by the user.

Functions of IR Image Management Server:

The IR image management server 50 includes a communication unit 51, a storage unit 52, and a storage location response unit 53. These functions of the IR image management server 50 are functions or means implemented by or caused to function by operating one or more hardware components illustrated in FIG. 5 in cooperation with instructions of the CPU 501 according to the program loaded from the HD 504 to the RAM 503.

The communication unit 51 communicates with the IR toner image management application 12 operating on the information processing apparatus 10 and receives the IR toner image and the print position. The storage unit 52 stores the IR toner image and the print position. In one example, the storage location is the IR image management server 50. In another example, the storage location is another server device than the IR image management server 50. The storage location response unit 53 creates the URL indicating the storage location.

Functions of Image Forming Apparatus:

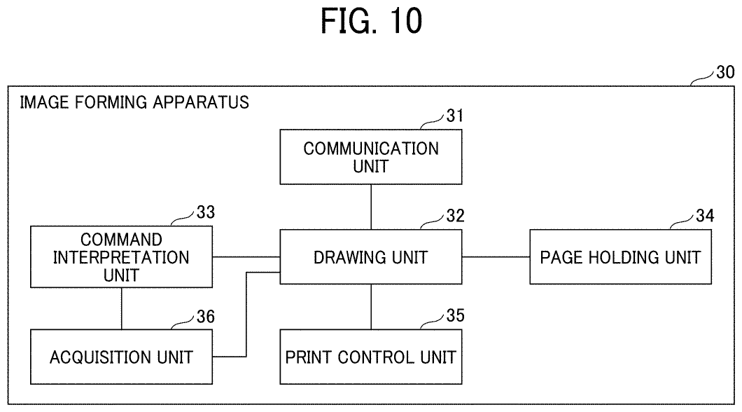

FIG. 10 is a block diagram illustrating a functional configuration of the image forming apparatus 30. The image forming apparatus 30 includes a communication unit 31, a drawing unit 32, a command interpretation unit 33, a page holding unit 34, a print control unit 35, and an acquisition unit 36. These functions of the image forming apparatus 30 are functions or means implemented by or caused to function by operating one or more hardware components illustrated in FIG. 6 in cooperation with instructions of the CPU 901 according to the program loaded from the HD 909 to the RAM 902b.

The communication unit 31 receives print data from the printer driver 11. The communication unit 31 is an example of a second communication unit. The drawing unit 32 interprets the print data received by the communication unit 31, to generate image data (bitmap data) for each page. The drawing unit 32 passes the image data to the print control unit 35. In interpreting the print data, when the print data includes a printing command, the drawing unit 32 passes the printing command to the command interpretation unit 33. The printing command is described in Printer Control Language (PCL) and designates, for example, where to form characters and images. This printing command further includes an instruction for printing with the IR toner. Further, there is a case where a URL is drawn at a predetermined position in the print image, and the printing command relating to the URL includes a setting that the URL relates to printing with the IR toner.

In a case that the print data is a page to be printed using the IR toner, the command interpretation unit 33 extracts the URL which is located at a predetermined position of the print image and in which information indicating the URL relates to printing using the IR toner is set about IR toner printing is set, and passes the URL to the acquisition unit 36. The acquisition unit 36 acquires the IR toner image and the print position from the storage destination designated by the URL, and passes the acquired IR toner image and print position to the drawing unit 32.

The drawing unit 32 creates image data in which image data of the IR toner image is overprinted on the print image at a position designated by the print position, and passes the created image data to the print control unit 35. The print control unit 35 receives image data for each page and forms an image on a sheet according to the received image data by using the printer 932.

Processes or Operation by Printer Driver:

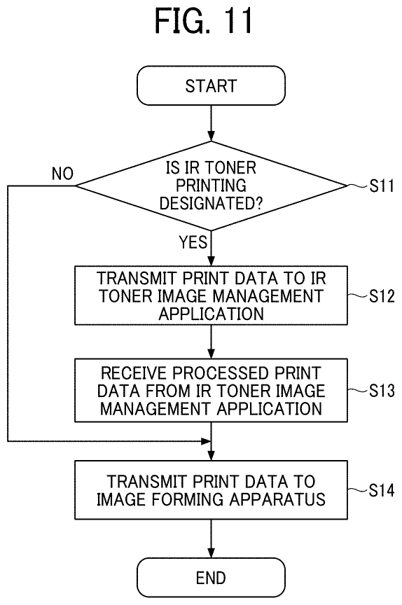

FIG. 11 is a flowchart illustrating an example of processes or operation performed by the printer driver 11. The operation illustrated in FIG. 11 starts in response to reception of print data by the printer driver 11 from a general-purpose application.

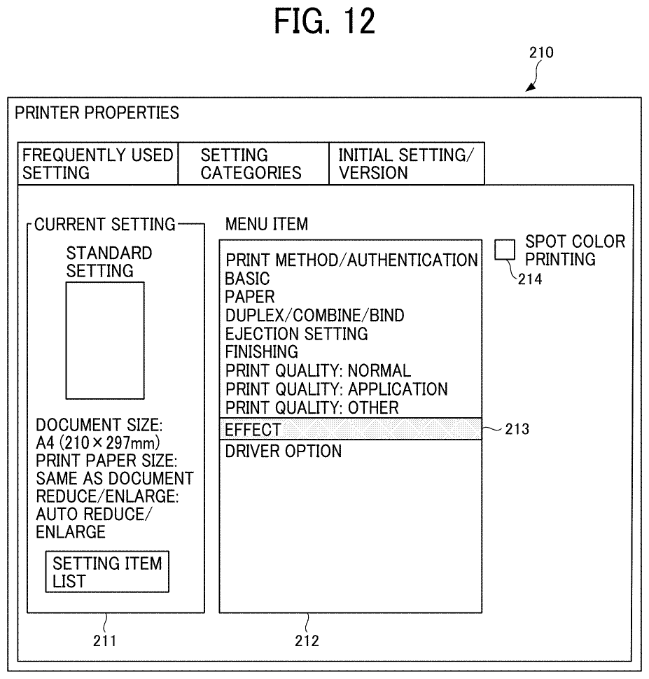

A user inputs a setting for printing using the IR toner on the print setting screen, which is described below with reference to FIG. 12. Since the settings holding unit 23 holds the setting for printing using the IR toner, the application invoking unit 24 refers to the settings holding unit 23 to determine whether printing using the IR toner is designated (S11). When the determination result of step S11 is No, the operation proceeds to step S14. In other words, the printer driver 11 converts a print image into print data and transmits the print data as is to the image forming apparatus 30 in the same or in substantially the same manner as printing using ordinary toner.

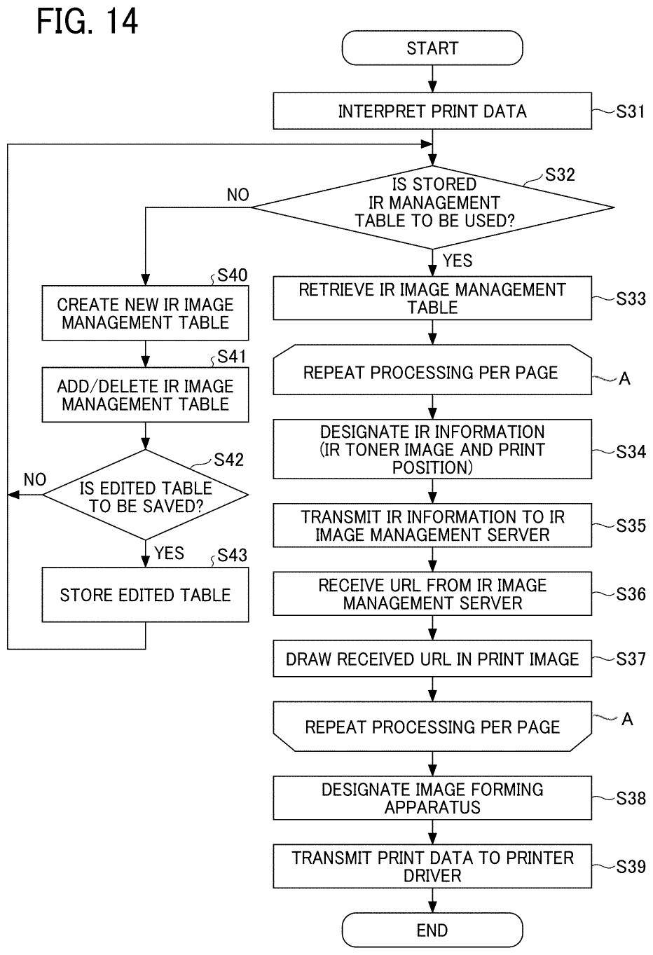

When the determination result of step S11 is Yes, the application invoking unit 24 passes the print data of the print image to the IR toner image management application 12 (S12). The IR toner image management application 12 executes processes of FIG. 14 described below.

The application invoking unit 24 receives, for each page of the print image print data to which the URL indicating the storage location of the IR toner image and the print position, from the IR toner image management application 12 (S13).

The communication unit 25 transmits the print data to the image forming apparatus 30 in page order (S14).

Example of Print Setting Screen:

FIG. 12 illustrates an example of a print setting screen 210. The print setting screen 210 includes a current setting field 211, a menu field 212, and a spot color print setting check box 214. The current print settings and a preview are displayed in the current setting field 211. In the menu field 212, print setting items are displayed so as to be selectable. Th print setting items includes an effect item 213. In response to pressing by a user of the effect item 213, the spot color print setting check box 214 is displayed. A user who wants to perform printing with the IR toner puts a mark in the spot color print setting check box 214. The operation receiving unit 22 of the printer driver 11 receives the designation by the user as to whether to perform printing with the IR toner.

Setting of IR Toner Image Management Application (IR Image Management Table) by User:

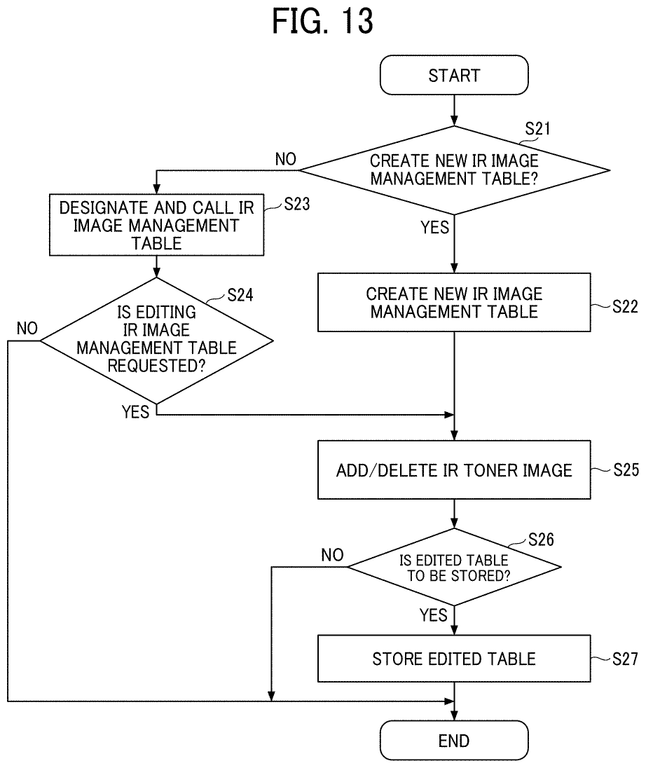

Referring to FIG. 13, a description is given of generation of the IR image management table, for which the user directly activates the IR toner image management application 12 on the information processing apparatus 10. FIG. 13 is a flowchart illustrating an example of processes or operation performed by the IR toner image management application 12 of receiving user settings for generating the IR image management table. The user can directly start the IR toner image management application 12 and control the IR toner image.

The operation receiving unit 42 of the IR toner image management application 12 determines whether the user operation is for creating a new IR image management table (S21). Creating an IR image management table means registering an IR toner image.

When the determination result of step S21 is Yes, the image management unit 44 creates a new IR image management table (S22).

When the determination result of step S21 is No, the image management unit 44 passes the list of existing IR image management tables to the display control unit 41 according to the user's operation (S23). The display control unit 41 displays the list of the IR image management table, and the operation receiving unit 42 determines whether the user's operation is for editing (changing) the IR image management table (S24). When the user's operation is not for changing the IR image management table (No in step S24), the operation of FIG. 13 ends.

When the new IR image management table is created (S22) or the IR image management table is changed (Yes in step S24) according to the user operation, the image management unit 44 adds or deletes the IR toner image or the memo (S25).

When the user's operation is for saving the IR image management table to which the IR toner image is added or deleted (Yes in S26), the image management unit 44 stores the corresponding IR image management table (S27).

Thus, the user can register the IR toner image in the IR toner image management application 12 in advance. Further, as described below with reference to FIG. 14, the user can also register the IR toner image in the IR toner image management application 12 at the time of printing.

Processes or Operation by IR Toner Image Management Application Invoked by Printer Driver:

FIG. 14 is a flowchart illustrating an example of processes or operation performed by the IR toner image management application 12 when the printer driver 11 invokes the IR toner image management application 12.

The IR toner image management application 12 receives the print data of the print image. The processing unit 45 receives the print data of the print image and interprets the page breaks and the number of pages (S31).

When the user uses the stored IR image management table (Yes in S32), the image management unit 44 retrieves the list of the IR image management tables according to the operation by the user (S33).

As described below, the processing unit 45 repeats processes for each page of the print image (loop A).

The operation receiving unit 42 receives designation of an IR toner image to be overprinted on the print image and a print position (S34).

The storage location information generation unit 43 transmits the IR toner image and the print position to the IR image management server 50 (S35). The storage location information generation unit 43 receives, from the IR image management server 50, a URL indicating a storage location of the IR toner image and the print position (S36).

The processing unit 45 adds, to a page of the print data, a printing command instructing that the page is to be printed with the IR toner, and draws a URL indicating the storage location at a predetermined position of the print image (S37). The predetermined position is preferably an inconspicuous place such as the upper right, lower right, lower left, or upper left of the print image. Further, the processing unit 45 sets a printing command indicating that the URL relates to IR toner printing. The reason why the printing command is set is that a URL unrelated to the storage location information is sometimes included in the print image. Black color (IR toner) is designated for the IR toner image and the URL.

The IR toner image management application 12 designates the image forming apparatus 30 for printing the print data after completion of the processing (S38). The designated image forming apparatus 30 is, for example, the image forming apparatus 30 that is set by the user with the printer driver 11.

After completion of the processing, the IR toner image management application 12 sends the processed print data to the printer driver 11 (S39).

By contrast, when the user does not use the stored IR image management table (No in S32), the image management unit 44 creates a new IR image management table (S40).

According to addition or deletion of the IR image management table performed by the user, the image management unit 44 adds or deletes the IR image management table (S41).

In response to the user's operation of saving the IR image management table that is added (Yes in S42), the image management unit 44 stores the corresponding IR image management table (S43).

In a case that the IR toner image does not change even when the print image changes, it is preferable that the IR toner image management application 12 has the association between the page number of the print image and the IR toner image. The IR toner image management application 12 can insert the IR toner image based on such association, thus dispensing the user from performing an operation of selecting an IR toner image.

Processes or Operation by IR Image Management Server:

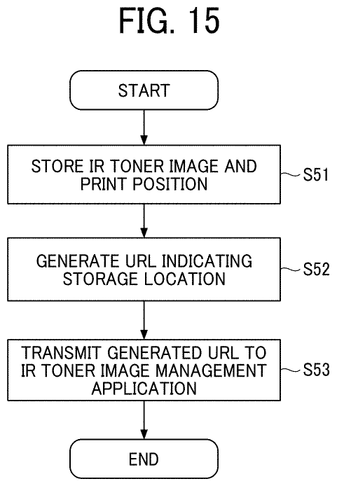

FIG. 15 is a flowchart illustrating an example of processes or operation performed by the IR image management server 50 of transmitting a URL to the IR toner image management application 12 in response to receiving the IR toner image and the print position.

The communication unit 51 of the IR image management server 50 receives an IR toner image and a print position from the information processing apparatus 10, and the storage unit 52 stores the IR toner image and the print position in a desired storage location (S51).

Next, the storage location response unit 53 creates a URL indicating a storage location where the IR toner image and the print position is stored (S52).

The communication unit 51 transmits the created URL to the information processing apparatus 10 (S53).

Although the description given referring to FIG. 14 and FIG. 15 is of an example in which the IR image management server 50 stores the URL and transmits the storage location information as a response to the information processing apparatus 10. In another example, the information processing apparatus 10 stores the IR toner image and the print position and generates the URL. In this case, the storage location information generation unit 43 stores the IR toner image and the print position in an external server and creates the URL indicating the storage location.

Processes or Operation Performed by Image Forming Apparatus:

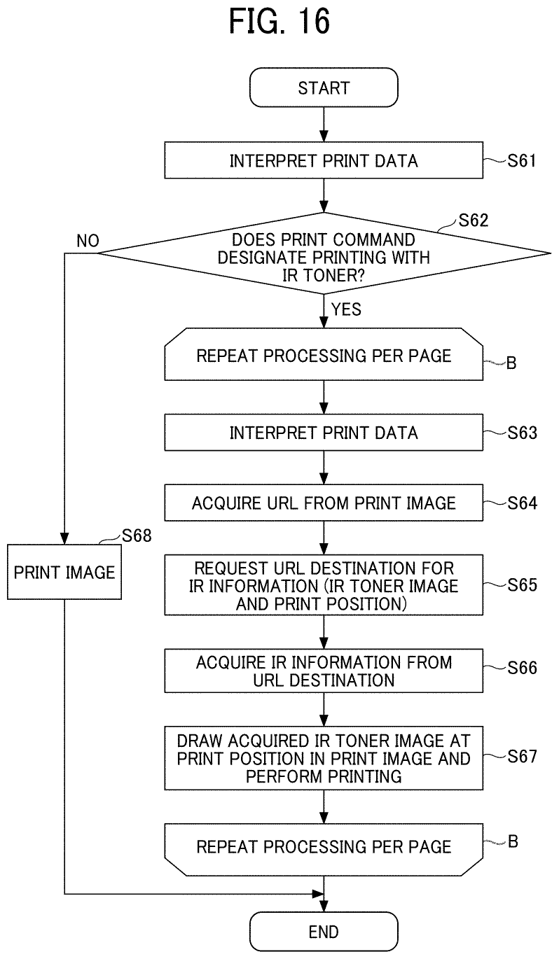

Referring to FIG. 16, a description is given of an operation performed by the image forming apparatus 30 of performing IR toner printing. FIG. 16 is a flowchart illustrating an example of processes or operation performed by the image forming apparatus 30 of performing printing according to print data. The operation of FIG. 16 starts in response to reception of print data by the communication unit 31 of the image forming apparatus 30.

First, the drawing unit 32 interprets, with the command interpretation unit 33, a printing command of the print data, page by page, to the last page (S61).

The drawing unit 32 determines whether the print data includes, at least, one page including the printing command instructing printing (overprinting) with the IR toner (S62).

When none of the pages includes the printing command instructing printing with the IR toner (No in S62), the drawing unit 32 generates image data (bitmap data) and sends the image data to the print control unit 35. The print control unit 35 controls the printer 932 to print the generated image data (S68).

When a printing command instructing printing with the IR toner is included in even one page (Yes in S62), loop B is executed for each page.

The command interpretation unit 33 interprets the printing command of the current page (S63). The command interpretation unit 33 determines whether the printing command of the current page includes the printing command instructing printing with the IR toner.

When the determination results indicates that the printing command of the current page includes the printing command instructing printing with the IR toner, the command interpretation unit 33 acquires the URL from the predetermined position of the print image (S64). The URL is identified by the presence of a character string such as “http://”. The command interpretation unit 33 determines whether the printing command includes a setting indicating that the URL relates to the IR toner image.

In a case that the URL including the setting indicating that the URL relates to the IR toner image is detected, the acquisition unit 36 requests the URL as a communication destination for the IR toner print image and the print position (S65), to acquire the IR toner image and the print position from the URL (S66).

Next, the drawing unit 32 superimposes the IR toner image at a position designated by the print position of the print image, to generate image data. The print control unit 35 controls the printer 932 to perform printing according to the generated image data (S67).

When the processing of loop B is completed to the last page, the operation of FIG. 16 ends.

Supplementary Description of IR Toner Printing by Image Forming Apparatus:

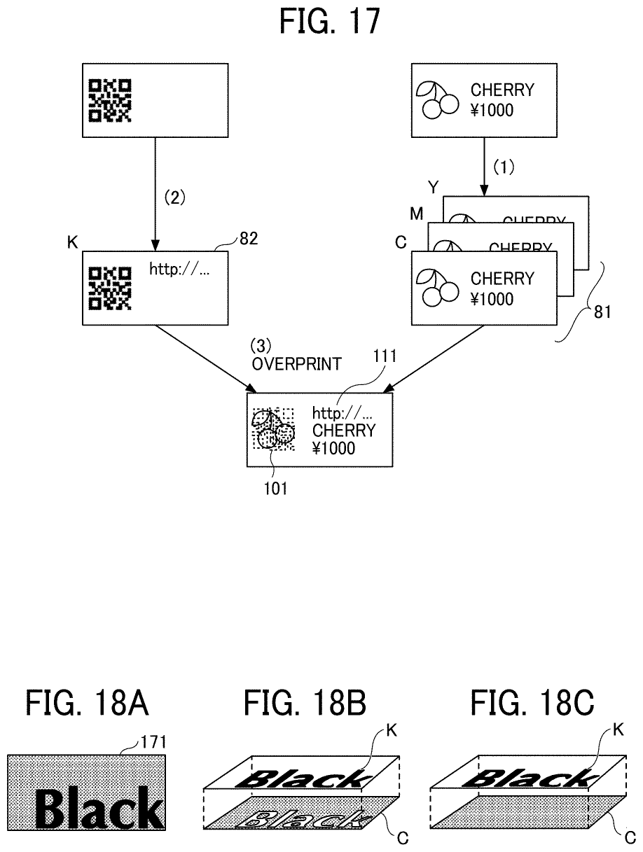

FIG. 17 is a diagram for describing an operation of printing with the IR toner performed by the image forming apparatus 30. The image forming apparatus 30 according to the present embodiment is a general-purpose image forming apparatus without a capability of an IR toner (spot color) designation (only cyan, magenta, yellow, and black can be designated). The image forming apparatus 30 according to the present embodiment is a color printer that performs printing with a combination of four colors of cyan, magenta, yellow, and black (C, M, Y, and K). The image forming apparatus 30 converts RGB print data output by the printer driver 11 into cyan print data, magenta print data, and yellow print data, respectively. In other words, the image forming apparatus 30 does not convert the RGB print data to black print data. Black can be expressed by cyan, magenta, and yellow of cyan, magenta, yellow, and black. A general-purpose image forming apparatus uses black to improve the color development property and reduce the amount of toner consumption. In the image forming apparatus 30 according to the present embodiment, the IR toner is assigned to black, since black can be printed without black toner. The IR toner is contained in the black toner cartridge instead.

(1) The image forming apparatus 30 generates a plain image 81 for each of cyan, magenta, and yellow based on the print image out of the print data transmitted from the information processing apparatus 10. In the plain image 81, the presence or absence of coloring is indicated by a bit, and the plain image 81 is image data in which each pixel is represented by 1 or 0.

(2) The image forming apparatus 30 converts the IR toner image and the URL in the print data transmitted from the information processing apparatus 10 into a black plain image 82. This is because black is assigned to the IR toner in the image forming apparatus 30, and the color may be converted into a vacant color (color is not assigned) in the image forming apparatus 30.

(3) The image forming apparatus 30 forms the plain image 81 of cyan with cyan toner, the plain image 81 of magenta with magenta toner, and the plain image 81 of yellow with yellow toner. The image forming apparatus 30 further forms the black plain image 82 with the IR toner in an overprinting manner. Thus, an output is obtained in which the IR toner image 101 and the URL 111 is printed with the IR toner.

As described above, the printing system 100 according to the present embodiment performs IR toner printing without an image forming apparatus capable of designating the IR toner, application software capable of designating the IR toner, or both.

Overprint:

In the present embodiment, overprinting is designated at the time of printing. Overprinting is printing one color superimposed on another color.

FIG. 18A to FIG. 18C illustrate an example of overprint. FIG. 18A illustrates an output 171 output by the image forming apparatus 30. The output 171 is printed in two colors, cyan for the background and black for text (Black). In other words, in the printing process, the plain image 81 of cyan and the black plain image 82 are generated. When overprint is not designated, as illustrated in FIG. 18B, the image forming apparatus 30 masks the black portion (in the outlined manner) to generate the plain image 81 of cyan. When the overprint is designated, as illustrated in FIG. 18C, the image forming apparatus 30 generates the plain image 81 of cyan without masking the black portion (without outlining).

When the overprint is not designated, the gap between the lower color (cyan in FIG. 18A to FIG. 18C) and the upper color (black in FIG. 18A to FIG. 18C) is sometimes noticeable. When the overprint is designated, there is a case that the two colors are undesirably mixed, and the color displayed by the application software is not reproduced in the output 171. The spot color in this embodiment is transparent. Even though the presence or absence of overprint is set according to the document, the lower color (photograph, etc.) is outlined when overprint is not designated. On the other hand, since the spot color is transparent, the color is unlikely to change even when overprint is designated. Accordingly, in the present embodiment, with the overprint designation, the black plain image 82 assigned with the spot color is printed. Cyan, magenta, and yellow can be without the designation of overprint.

As described above, the printing system 100 according to the present embodiment can perform printing using the IR toner with application software that handles general RGB image data. Further, users can use the entire page to design a print image.

Variation:

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

For example, in the present embodiment, a toner transparent to visible light is used. Alternatively, the image forming apparatus 30 performs printing using colors, such as gold, silver, and white, other than cyan, magenta, yellow, and black.

Further, the present embodiment mainly concerns electrophotographic printing. In another example, aspects of the present disclosure are suitably applicable to an inkjet printer that discharges liquid droplets.

The functional configurations of the information processing apparatus 10 and the image forming apparatus 30 are divided into the functional blocks as illustrated in FIG. 7, for example, based on main functions of the display apparatus, in order to facilitate understanding the processes performed by the display apparatus. The scope of the present disclosure is not limited by how the process units are divided or by the names of the process units. In another example, the processes implemented by the information processing apparatus 10 and the image forming apparatus 30 are divided to a larger number of processes depending on the contents of processes. In still another example, one process is divided to include the larger number of processes.

The apparatuses or devices described in one or more embodiments are just one example of plural computing environments that implement the one or more embodiments disclosed herein. In some embodiments, the IR image management server 50 includes multiple computing devices, such as a server cluster. The multiple computing devices communicate with one another through any type of communication link including, for example, a network or a shared memory, and perform the operations described in the present disclosure.

Further, the IR image management server 50 can be configured to share the disclosed processes, for example, the processes illustrated in FIG. 15 with any server in various combinations. For example, a process performed by a given unit is performed by a plurality of information processing apparatuses included in the IR image management server 50. Further, in one example, the elements of the IR image management server 50 are combined into one apparatus or are divided into a plurality of apparatuses.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

In the related art, a design of an image to be printed is restricted. The term “design” refers to arrangement and color scheme of text, figures, images, etc. In other words, an information processing apparatus embeds an image such as a barcode to be printed in a specific color in a page of an image to be printed, and an image forming apparatus outlines the barcode at the time of printing. The outlined portion is made blank. If the image forming apparatus does not outline the image such as a barcode, the image remains. Thus, in the related art, there is a restriction that an image to be printed cannot be designed using the entire page of the image to be printed.

According to one or more embodiments of the present disclosure, a specific color is printed while reducing restrictions on a design on an image to be printed.

According to a first example of the present disclosure, a printing system is communicable with an image management server through a network. The printing system includes an information processing apparatus including first circuitry, and an image forming apparatus including second circuitry. The first circuitry of the information processing apparatus controls a display to display a print setting screen for receiving a print setting that designates printing of a specific color image superimposed on an image to be printed, the specific color image being an image of a specific color. The first circuitry of the information processing apparatus, in response to receiving the print setting via the print setting screen, transmits the specific color image corresponding to the print setting to the image management server through the network. The first circuitry of the information processing apparatus acquires storage location information indicating a storage location where the specific color image is stored from the image management server. The first circuitry of the information processing apparatus transmits print data to the image forming apparatus, the print data including a printing command including the print setting indicating that the specific color image is to be superimposed and printed on the image to be printed, the image to be printed, and the acquired storage location information. The image forming apparatus includes a printer. The second circuitry of the image forming apparatus receives the print data. The second circuitry of the image forming apparatus acquires the specific color image from the image management server based on the storage location information included in the received print data. The second circuitry of the image forming apparatus generates, based on the printing command included in the print data, image data for overprinting the specific color image acquired from the image management server on the image to be printed included in the print data. The second circuitry of the image forming apparatus controls the printer to perform printing based on the generated image data.

According to a second example of the present disclosure, in the printing system of the above first example, the first circuitry of the information processing apparatus includes the storage location information in the image to be printed, the first circuitry of the information processing apparatus transmits the print data including the image to be printed including the storage location information and the printing command to the image forming apparatus.

According to a third example of the present disclosure, in the printing system of the above second example, the first circuitry of the information processing apparatus draws the storage location information on the image to be printed. The first circuitry of the information processing apparatus causes the printing command to include a setting indicating that the specific color image is to be printed in the specific color. The second circuitry of the image forming apparatus detects the storage location information from the image to be printed. The second circuitry of the image forming apparatus detects that the specific color image is to be printed in the specific color from the printing command. The second circuitry of the image forming apparatus, in a case that the second circuitry detects the storage location information from the image to be printed and detects that the specific color image is to be printed in the specific color from the printing command, acquires the specific color image from the image management server based on the storage location information.

According to a fourth example of the present disclosure, in the printing system of the above third example, the second circuitry of the image forming apparatus is further configured to control the printer to overprint the specific color image on the image to be printed and to overprint the storage location information in the specific color on the image to be printed.

According to a fifth example of the present disclosure, in the printing system of any one of the above first to fourth examples, the first circuitry of the information processing apparatus receives a setting of a position of the specific color image in the image to be printed via the print setting screen. The first circuitry of the information processing apparatus transmits the specific color image corresponding to the print setting and position information relating to the position of the specific color image to the image management server through the network. The first circuitry of the information processing apparatus acquires the storage location information including the specific color image and the position information from the image management server. The second circuitry of the image forming apparatus overprints the specific color image acquired from the image management server at the position indicated by the position information in the image to be printed.

According to a sixth example of the present disclosure, in the printing system of any one of the above first to fifth examples, the storage location information is a URL.

According to a seventh example of the present disclosure, in the printing system of any one of the above first to sixth examples, the specific color is a color transparent to visible light.

1. A printing system communicable with an image management server through a network, the printing system comprising:
an information processing apparatus including first circuitry; and
an image forming apparatus including second circuitry,
the first circuitry of the information processing apparatus being configured to
control a display to display a print setting screen for receiving a print setting that designates printing of a specific color image superimposed on an image to be printed, the specific color image being an image of a specific color,
in response to receiving the print setting via the print setting screen, transmit the specific color image corresponding to the print setting to the image management server through the network,
acquire storage location information indicating a storage location where the specific color image is stored from the image management server, and
transmit print data to the image forming apparatus, the print data including a printing command including the print setting indicating that the specific color image is to be superimposed and printed on the image to be printed, the image to be printed, and the acquired storage location information,
the image forming apparatus including a printer,
the second circuitry of the image forming apparatus being configured to
receive the print data,
acquire the specific color image from the image management server based on the storage location information included in the received print data,
generate, based on the printing command included in the print data, image data for overprinting the specific color image acquired from the image management server on the image to be printed included in the print data, and
control the printer to perform printing based on the generated image data.

2. The printing system of claim 1, wherein
the first circuitry of the information processing apparatus is further configured to
include the storage location information in the image to be printed, and
transmit the print data including the image to be printed, the storage location information, and the printing command to the image forming apparatus.

3. The printing system of claim 2, wherein
the first circuitry of the information processing apparatus is further configured to:
draw the storage location information on the image to be printed; and
cause the printing command to include a setting indicating that the specific color image is to be printed in the specific color, and
the second circuitry of the image forming apparatus is further configured to:
detect the storage location information from the image to be printed;
detect that the specific color image is to be printed in the specific color from the printing command; and
in a case that the second circuitry detects the storage location information from the image to be printed and detects that the specific color image is to be printed in the specific color from the printing command, acquire the specific color image from the image management server based on the storage location information.

4. The printing system of claim 3, wherein the second circuitry of the image forming apparatus is further configured to control the printer to overprint the specific color image on the image to be printed and to overprint the storage location information in the specific color on the image to be printed.

5. The printing system of claim 1, wherein
the first circuitry of the information processing apparatus is further configured to:
receive a setting of a position of the specific color image in the image to be printed via the print setting screen;
transmit the specific color image corresponding to the print setting and position information relating to the position of the specific color image to the image management server through the network; and
acquire the storage location information including the specific color image and the position information from the image management server, and
the second circuitry of the image forming apparatus is further configured to overprint the specific color image acquired from the image management server at the position indicated by the position information in the image to be printed.

6. The printing system of claim 1, wherein the storage location information is a uniform resource locator (URL).

7. The printing system of claim 1, wherein the specific color is a color transparent to visible light.

8. A non-transitory computer-executable medium storing a program storing instruction, which, when executed by one or more processors of an information processing apparatus that transmits print data to an image forming apparatus and is communicable with an image management server through a network, to perform a method comprising:
controlling a display to display a print setting screen for receiving a print setting that designates printing of a specific color image superimposed on an image to be printed, the specific color image being an image of a specific color;
in response to receiving the print setting via the print setting screen, transmitting the specific color image corresponding to the print setting to the image management server through the network;
acquiring storage location information indicating a storage location where the specific color image is stored from the image management server; and
transmitting print data to the image forming apparatus, the print data including a printing command including the print setting indicating that the specific color image is to be superimposed and printed on the image to be printed, the image to be printed, and the acquired storage location information.

9. An image forming apparatus communicable with an image management server through a network, the image forming apparatus comprising:
a printer;
circuitry configured to:
receive print data from an information processing apparatus;
the information processing apparatus including another circuitry configured to
controlling a display to display a print setting screen for receiving a print setting that designates printing of a specific color image superimposed on an image to be printed, the specific color image being an image of a specific color,
in response to receiving the print setting via the print setting screen, transmit the specific color image corresponding to the print setting to the image management server through the network,
acquire storage location information indicating a storage location where the specific color image is stored from the image management server, and
transmit the print data to the image forming apparatus, the print data including a printing command including the print setting indicating that the specific color image is to be superimposed and printed on the image to be printed, the image to be printed, and the acquired storage location information,
acquire the specific color image from the image management server based on the storage location information included in the received print data;
generate, based on the printing command included in the print data, image data for overprinting the specific color image acquired from the image management server on the image to be printed included in the print data; and
control the printer to perform printing based on the generated image data.
